(19) United States
(12) Patent Application Publication
(10) Pub. No.: US 2025/0198026 A1
(43) Pub. Date: Jun. 19, 2025

(54) COMPONENTS FOR WATER OXIDATION ALKALINE AND ALKALINE MEMBRANE ELECTROLYZERS

(71) Applicant: University of Oregon, Eugene, OR (US)

(72) Inventors: Shannon Boettcher, Eugene, OR (US); Tingting Zhai, Eugene, OR (US); Minkyoung Kwak, Eugene, OR (US); Liam Twight, Eugene, OR (US)

(73) Assignee: University of Oregon, Eugene, OR (US)

(21) Appl. No.: 18/978,848

(22) Filed: Dec. 12, 2024

Related U.S. Application Data
(60) Provisional application No. 63/609,811, filed on Dec. 13, 2023.

(51) Int. Cl. C25B 11/067; C25B 11/052

(52) U.S. Cl. CPC C25B 11/067; C25B 11/052

(57) ABSTRACT

Disclosed herein are aspects of a composition comprising one or more metal-oxide nanoparticles and porous catalyst layers, comprising an electrically conductive core a surface layer comprising one or more surface active catalysts; and wherein the one or more metal-oxide nanoparticles are electrocatalytic toward oxygen gas evolution in alkaline conditions, alkaline-ionomer conditions, or a combination thereof. Aspects of a method of making such compositions for water oxidation alkaline and alkaline membrane electrolyzers are also disclosed herein. Also disclosed herein is an alkaline-exchange-membrane ionomer-based, hybrid liquid-alkaline, alkaline-ionomer electrolyzer comprising an anode, wherein the anode comprises (i) an ionomer and (ii) the composition disclosed herein and a liquid alkaline electrolyzer comprising an anode, wherein the anode comprises one or more catalysts having the composition disclosed herein, wherein the composition is produced as a powder or as a continuous electrode architecture on metal porous transport layers.

### CROSS REFERENCE TO RELATED APPLICATION

This application claims the benefit of and priority to the earlier filing date of U.S. Provisional Patent Application No. 63/609,811, filed on Dec. 13, 2023, the entirety of which is incorporated herein by reference.

### ACKNOWLEDGMENT OF GOVERNMENT SUPPORT

This invention was made with government support under 1955106 awarded by the National Science Foundation and DE-EE0008841 awarded by the Department of Energy. The government has certain rights in the invention.

### FIELD

The present disclosure concerns catalyst compositions and methods of making and using such compositions.

### BACKGROUND

The oxygen evolution reaction (OER) is the half-cell reaction in the water splitting process required for electrochemical energy conversion and storage systems such as hydrogen fuels and water electrolyzers. More specifically, alkaline membrane and liquid alkaline electrolyzers operate via transport of hydroxide ions through the electrolyte from the cathode to the anode with hydrogen being generated on the cathode. Catalysts used in such applications must be electronically conductive materials, but most metallic materials are not stable under water oxidation conditions and therefore oxidize. Most oxides are electronic insulators or semiconductors and classes of electronic metallic metal oxides, such as metal-oxide perovskites, have been of recent interest. However, the underlying challenge has been that high conductivity is connected to high crystallinity and large grain/particle sizes but the active phases for the oxygen evolution catalysis reaction in metal-oxide perovskites are not crystalline metal oxides but disordered phases with an oxyhydroxide structure. Therefore, there is a fundamental performance trade-off.

### SUMMARY

Disclosed herein is a composition comprising a core comprising one or more metal-oxide perovskite nanoparticles having a formula ABQ, wherein A is La, Sr, or any combination thereof; B is one or more transition metal cations; and Q is Cl_{y}O_{3-y/2} or F_{z}O_{3-z/2}, y is 0 to 3, and z is 0 to 3; a surface layer comprising one or more surface active catalysts; and wherein the one or more metal-oxide nanoparticles are electrocatalytic toward oxygen gas evolution in alkaline conditions, alkaline-ionomer conditions, or a combination thereof.

Also disclosed herein is a method of making the composition disclosed herein comprising: providing a stoichiometric amount of one or more metal salt compounds, a solvent, and a chelating agent or surfactant to form a reaction mixture; stirring the reaction mixture; heating the reaction mixture to a temperature ranging from 80° C. to 150° C. to provide a gel; heating the gel to a temperature ranging 300° C. to 500° C. to obtain a solid precursor material; grinding and/or ball milling the solid precursor material; and calcining the ground precursor material at a temperature ranging from 400° C. to 900° C.

A method of making an anode is also disclosed herein, the method comprising: providing a coating ink comprising: a stoichiometric amount of one or more metal salt compounds, a solvent, a chelating agent or surfactant, and one or more perovskite nanoparticles having a formula ABQ, wherein: A is La, Sr, or any combination thereof; B is one or more transition metal cations; and Q is Cl_{y}O_{3-y/2} or F_{z}O_{3-z/2}, y is 0 to 3, and z is 0 to 3; stirring the coating ink; spraying the coating ink onto a substrate; heating the spray coated substrate to a temperature ranging from 25° C. to 800° C. to provide a precursor anode; and heating the precursor anode to a temperature ranging from 100° C. to 1000° C.

Also disclosed herein is an alkaline-exchange-membrane ionomer-based, hybrid liquid-alkaline, alkaline-ionomer electrolyzer comprising an anode, wherein the anode comprises (i) an ionomer and (ii) the composition disclosed herein.

A liquid alkaline electrolyzer comprising an anode is also disclosed herein, wherein the anode comprises one or more catalysts comprising the composition disclosed herein.

The foregoing and other objects, features, and advantages of the present disclosure will become more apparent from the following detailed description, which proceeds with reference to the accompanying figures.

### BRIEF DESCRIPTION OF THE DRAWINGS

FIG. 1 shows the XRD patterns of Sr_{0.1}La_{0.9}Fe_{0.05}Ni_{0.3}Co_{0.65}O₃; Sr_{0.1}La_{0.9}Ni_{0.3}Co_{0.7}O₃; LaNi_{0.3}Co_{0.7}O₃; LaNi_{0.5}Co_{0.5}O₃; LaCoO₃; LaNiO₃; and LaNiO₃ (JCPDS NO. 10-0341) and LaCoO₃ (JCPDS NO. 09-0358).

FIG. 2 shows the electrical conductivities (mS/cm) at room temperature of commercial Co₃O₄ (30-50 nm, 1.8×10⁻¹ mS/cm) and compared to LaCoO₃ (1.2×10² mS/cm); LaNi_{0.1}Co_{0.9}O₃ (8.4×10³ mS/cm); Sr_{0.2}La_{0.8}Fe_{0.05}Ni_{0.3}Co_{0.65}O₃ (7.30×10⁴ mS/cm); Sr_{0.1}La_{0.9}Fe_{0.1}Ni_{0.3}Co_{0.6}O₃ (8.81×10⁴ mS/cm); Sr_{0.1}La_{0.9}Fe_{0.05}Ni_{0.3}Co_{0.65}O₃ (8.85×10⁴ mS/cm); LaNi_{0.3}Co_{0.7}O₃ (1.06×10⁵ mS/cm); Sr_{0.1}La_{0.9}Ni_{0.3}Co_{0.7}O₃ (1.29×10⁵ mS/cm); Sr_{0.1}La_{0.9}Ni_{0.5}Co_{0.5}O₃ (1.50×10⁵ mS/cm); LaNi_{0.5}Co_{0.5}O₃ (1.86×10⁵ mS/cm); LaNi_{0.7}Co_{0.3}O₃ (2.39×10⁵ mS/cm); LaNi_{0.9}Co_{0.1}O₃ (2.84×10⁵ mS/cm); and LaNiO₃ (4.30×10⁵ mS/cm).

FIG. 3A shows an image obtained through scanning electron microscopy (SEM) of LaNiO₃ (scale bar, 200 nm).

FIG. 3B shows an image obtained through SEM of LaCoO₃ (scale bar, 200 nm).

FIG. 3C shows an image obtained through SEM of LaNi_{0.5}Co_{0.5}O₃ (scale bar, 200 nm).

FIG. 3D shows an image obtained through SEM of LaNi_{0.3}Co_{0.7}O₃ (scale bar, 200 nm).

FIG. 3E shows an image obtained through SEM of Sr_{0.1}La_{0.9}Ni_{0.3}Co_{0.7}O₃ (scale bar, 200 nm).

FIG. 3F shows an image obtained through SEM of Sr_{0.1}La_{0.9}Fe_{0.05}Ni_{0.3}Co_{0.65}O₃ (scale bar, 200 nm).

FIG. 4 shows the cyclic voltammetry (CV) scans for Sr_{0.1}La_{0.9}Fe_{0.1}Ni_{0.3}Co_{0.6}O₃; Sr_{0.1}La_{0.9}Ni_{0.3}Co_{0.7}O₃; Sr_{0.1}La_{0.9}Fe_{0.05}Ni_{0.3}Co_{0.65}O₃; LaCoO₃; LaNi_{0.3}Co_{0.7}O₃; LaNiO₃; and commercial Co₃O₄ (30-50 nm) in Fe-free 1 M KOH.

FIG. 5 shows the polarization curves of AEMWE single cell of anode catalysts LaNiO₃; LaCoO₃; LaNi_{0.3}Co_{0.7}O₃; Sr_{0.1}La_{0.9}Ni_{0.3}Co_{0.7}O₃; Sr_{0.1}La_{0.9}Fe_{0.1}Ni_{0.3}Co_{0.6}O₃; Sr_{0.1}La_{0.9}Fe_{0.05}Ni_{0.3}Co_{0.65}O₃; and commercial Co₃O₄ (30-50 nm) operated at 55° C. with pure water feed (data presented as mean±one standard deviation).

FIG. 6 shows the durability testing data (at 500 mA cm⁻² for 20 h at 55° C. with pure water feed) for commercial Co₃O₄ (30-50 nm, 3.4 mV/h); LaCoO₃; Sr_{0.1}La_{0.9}Fe_{0.05}Ni_{0.3}Co_{0.65}O₃ (9.9 mV/h); LaNiO₃ (13.4 mV/h); LaNi_{0.5}Co_{0.5}O₃ (5.0 mV/h); and Sr_{0.1}La_{0.9}Ni_{0.3}Co_{0.7}O₃ (4.5 mV/h).

FIG. 7 shows the XRD patterns of self-supported perovskite anode prepared by “Brick and Mortar” method (labeled as B-M anode), and conventional perovskite catalyst-ionomer-coated anode (labeled as CIC anode), Sr/Co doped LaNiO₃ perovskite powder and standard XRD profiles of LaNiO₃ (JCPDS NO. 10-0341).

FIG. 8 shows the electrical conductivities (mS/cm) of pristine powder, powder from “Brick” anode at room temperature, wherein no “Mortar” was used, and powder from “B-M” anode.

FIG. 9A shows an image obtained through scanning electron microscopy (SEM) of “B-M” anode (scale bar, 10 μm).

FIG. 9B shows a cross-sectional image obtained through SEM of “B-M” anode (scale bar, 10 μm).

FIG. 9C shows a cross-sectional image obtained through SEM of “B-M” anode with PiperION ionomer (scale bar, 1 μm).

FIG. 9D shows a cross-sectional image obtained through SEM of “CIC” anode.

FIG. 10 shows the polarization curves of AEMWE single cell with “B-M” anode and “CIC” anode operated at 70° C. with pure water feed (scale bar, 1 μm).

FIG. 11 shows cyclic voltammetry (CV) curves of AEMWE single cell with “B-M” anode and “CIC” anode in a non-faradaic region at a scan rate of 100 mV s⁻¹ operated at 70° C. with pure water feed.

FIG. 12 shows the durability testing data (at 1 A cm⁻² at 70° C. with pure water feed) for AEMWE single cell with “B-M” anode and “CIC” anode.

### DETAILED DESCRIPTION

### I. Overview of Terms, Ranges, and Definitions

Both the foregoing general description and the following detailed description are exemplary and explanatory only and are not intended to limit the scope of the present disclosure.

As used herein, the use of the singular includes the plural unless specifically stated otherwise. For example, the singular forms “a”, “an” and “the” as used in the specification also include plural aspects unless the context dictates otherwise. Similarly, any singular term used in the specification also means plural or vice versa, unless the context dictates otherwise.

In some examples, values, procedures, or devices may be referred to as “lowest,” “best,” “minimum,” or the like. It will be appreciated that such descriptions are intended to indicate that a selection among many used functional alternatives can be made, and such selections need not be better, smaller, or otherwise preferable to other selections.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting, unless otherwise indicated. Other features of the disclosure are apparent from the following detailed description and the claims.

Unless otherwise indicated, all numbers expressing quantities of components, molecular weights, percentages, temperatures, times, and so forth, as used in the specification or claims are to be understood as being modified by the term “about.” Accordingly, unless otherwise indicated, implicitly or explicitly, the numerical parameters set forth are approximations that can depend on the desired properties sought and/or limits of detection under standard test conditions/methods. When directly and explicitly distinguishing embodiments from discussed prior art, the embodiment numbers are not approximates unless the word “about” is recited. Furthermore, not all alternatives recited herein are equivalents.

The term “or combinations thereof” as used herein refers to all permutations and combinations of the listed items preceding the term. For example, “A, B, C, or combinations thereof” is intended to include at least: A, B, C, AB, AC, BC, or ABC, and if order is important in a particular context, also BA, CA, CB, ACB, CBA, BCA, BAC, or CAB. Continuing with this example, expressly included are combinations that contain repeats of one or more item or term, such as BB, AAA, AAB, BBC, AAABCCCC, CBBAAA, CABABB, and so forth.

All literature and similar materials cited in this application including, but not limited to, patents, patent applications, articles, books, treatises, and internet web pages, regardless of the format of such literature and similar materials, are expressly incorporated by reference in their entirety for any purpose. In the event that one or more of the incorporated literature and similar materials defines or uses a term in such a way that it contradicts that term's definition in this application, the definitions provided by this specification control. While the present teachings are described in conjunction with various embodiments, it is not intended that the present teachings be limited to such embodiments. On the contrary, the present teachings encompass various alternatives, modifications, and equivalents, as will be appreciated by a person of ordinary skill in the art in light of the present teachings.

### II. Introduction

Catalysts used in alkaline membrane and liquid alkaline devices must be electronically conductive materials. Most metallic materials are not stable under water oxidation conditions (i.e., oxidize to oxides) and most oxides are electronic insulators or semiconductors. More specifically, metal-oxide perovskites, a class of electronic metallic metal oxides, can be made with highly diverse metal cations and tuned in composition. The underlying challenge, however, is that high conductivity is connected to high crystallinity and large grain/particle size, yet the active phases are not crystalline metal oxides but disordered phases with an oxyhydroxide-type structure. Disclosed herein are aspects of a composition circumventing this trade-off.

### III. Composition

Certain disclosed aspects of the present disclosure concern a composition comprising an earth abundant elemental composition; metallic electronic properties and high electronic conductivity; and a surface-active phase that is dynamically formed during operation having a controlled thickness. In aspects disclosed herein, the thickness of the active phase is controlled for integration with an alkaline ionomer and/or liquid alkaline electrolyte (such as, but not limited to, KOH, NaOH, in water) and modulated by choice of compounds disclosed herein.

In particular aspects disclosed herein, the composition comprises one or more metal-oxide nanoparticles comprising a core and a surface layer. In some aspects, the composition can comprise one or more metal-oxide nanoparticle powders, porous catalysts layers, or combination thereof. Typically, the core is electrically conductive; and the surface layer is electrocatalytic toward oxygen gas evolution in liquid alkali, alkaline-ionomer, or combination thereof. In particular aspects disclosed herein, the electrolytes are solid, liquid, or any combination thereof.

In some aspects, the core composition can comprise one or more metal-oxide perovskite nanoparticles according to Formula I(a), where A is one or more rare earth metals (such as, but not limited to, lanthanide element) cations, one or more alkaline earth metal (such as, but not limited to, Group 2 element) cations, or any combination thereof; B is one or more transition metal cations; Q is O, O and F, or O and Cl. In certain aspects, Q can be Cl_{y}O_{3-y/2} or F_{z}O_{3-z/2}, wherein y is 0 to 6, and z is 0 to 6.

ABQ Formula I(a)

In certain aspects disclosed herein, the core composition comprises one or more metal-oxide perovskite nanoparticles according to Formula I(b), where A is La, Sr, or any combination thereof; and B is NiₓCo₁₋ₓ; and x is 0 to 1. Typically, the stoichiometry of 0 ranges from 2-3. In a non-limiting example, A is La, Sr, or any combination thereof; and B is NiₓCo₁₋ₓ; and x is 0 to 1.

ABO₃ Formula I(b)

In certain aspects disclosed herein, the surface layer is on the core (e.g., positioned above the core), which can comprise one or more surface-active catalysts. In some aspects, the one or more surface-active catalysts can comprise any element having an atomic number from 21 to 30. Without being bound by a particular theory of operation, in some aspects disclosed herein, the surface layer can further comprise any Group 2 element, wherein the Group 2 element leaches from the catalyst materials to expedite and/or increase the extent of formation of the catalytically active phase on the surface layer of the conductive nanoparticle core.

In particular aspects disclosed herein, the core, surface layer comprising one or more surface active catalysts, or any combination thereof comprise any lanthanide element substituted for La such that the total molar sum of La and additional substituted elements equal to 1. In some aspects of the present disclosure, the electrically conductive core can be represented by Formula II, where x is 0 to 1.

LaNiₓCo₁₋ₓO₃, Formula II

In aspects disclosed herein, the surface layer comprises one or more metal oxides or (oxy)hydroxides comprising Ni, Co, or both Ni and Co, that are the active phase catalysts. In non-limiting examples the composition can be: LaNi_{0.9}Co_{0.1}O₃; LaNi_{0.9}Co_{0.1}O₃; LaNi_{0.5}Co_{0.5}O₃; LaNi_{0.3}Co_{0.7}O₃; or LaNi_{0.1}Co_{0.9}O₃.

In aspects disclosed herein, the composition may further comprise Cl or F in the oxygen position according to Formula III, Formula IV, and related compounds, where x is 0 to 1, y is 0 to 6, and z is 0 to 6. In certain aspects, Cl and F can also be mixed together on the 0 positions, such that y+z can have a range from 0 to 6.

LaNiₓCo₁₋ₓCl_{y}O_{3-y/2} Formula III

LaNiₓCo₁₋ₓF_{z}O_{3-z/2} Formula IV

In some aspects, Be, Mg, Ca, Sr, Ba, Ra, or any combination thereof are introduced into the oxide structure to facilitate restructuring and increased thickness of the active surface phase near the ionomer by leaching from the nanoparticle under operation to allow restructuring of the crystalline oxide to the active surface phase. The degree of restructuring can also be tuned by the Co to Ni ratio in the metal-oxide and by increasing the Ni content, the restructuring increases. By increasing the Co amount (from a 1:1 ratio) stabilizes the crystalline phase. In non-limiting examples, the composition can be Sr_{0.1}La_{0.9}Ni_{0.5}Co_{0.5}O₃ or Sr_{0.1}La_{0.9}Ni_{0.3}Co_{0.7}O₃.

In certain aspects, the one or more metal-oxide perovskite nanoparticles can further comprise Sc, Ti, V, Cr, Mn, Fe, Cu, or any combination thereof. In some aspects disclosed herein, Fe is added to the nanoparticle composition to increase the kinetics of the water oxidation reaction. In particular aspects disclosed herein, B of Formula I may further comprise Fe substituting Co with a mol % no greater than 50%. In non-limiting examples, the composition can be Sr_{0.1}La_{0.9}Fe_{0.05}Ni_{0.3}Co_{0.65}O₃; Sr_{0.1}La_{0.9}Fe_{0.1}Ni_{0.3}Co_{0.6}O₃; or Sr_{0.2}La_{0.8}Fe_{0.05}Ni_{0.3}Co_{0.65}O₃.

In some aspects disclosed herein, the core can have a diameter ranging from 2 nm to 200 nm. In aspects disclosed herein, the thickness of the active phase is controlled for desirable integration with the ionomer and modulated by a specific composition. In some aspects, the nanoparticle catalyst surface layer has a thickness of 1 nm to an upper limit equal to but not exceeding the particle diameter.

In certain aspects disclosed herein, the surface layer comprising one or more surface active phase catalysts are formed by electrochemical reconstruction of the surface layer. In particular aspects disclosed herein, the surface layer comprising one or more surface active phase catalysts are formed via constant current electrodeposition from a solution comprising one or more water-soluble metal salts. In some aspects disclosed herein, the surface layer comprising one or more surface phase catalysts are formed via physical or chemical deposition methods followed by constant current application induced by an applied oxidative voltage.

In some aspects disclosed herein, the composition disclosed herein can be a powder (e.g., nano-powder), which is redispersed in a solvent mixed with one or more metal salts and a chelating agent or surfactant, then spray-coated on a PTL (porous transport layer) to construct a continuous porous layer of metallic perovskite oxides, followed by heat treatment. This continuous but porous catalyst layer increases the particle-to-particle connectivity, lowers the electrical resistivity of the catalyst layer, as well as increases the electrochemically active surface area.

In certain aspects disclosed herein, the electronic conductivity of the composition disclosed herein has a range of from 1 S/m to 10⁷ S/m.

### IV. System

The present disclosure also concerns embodiments of a system comprising the composition disclosed herein. In some aspects of the present disclosure, the system can be an alkaline-exchange-membrane ionomer-based electrolyzer. In certain aspects of the present disclosure, the system can be a hybrid liquid-alkaline/alkaline-ionomer electrolyzer. In aspects disclosed herein, the system can be a liquid-alkaline electrolyzer. Typically, the alkaline-ionomer electrolyzer, hybrid liquid-alkaline/alkaline-ionomer, and liquid alkaline electrolyzer comprises an anode.

In some aspects of the present disclosure, the anode may comprise an ionomer and the composition disclosed herein. In certain aspects, the composition disclosed herein the anode comprises the composition disclosed herein, wherein the composition is a catalyst in the system.

In aspects of the present disclosure, the composition disclosed herein can be formulated for catalyzing an oxygen evolution reaction (OER). In certain aspects, the composition disclosed herein can be used as a catalyst to perform a water oxidation reaction.

### V. Method of Making

Aspects of the present disclosure also concern a method for making the composition or system according to the present disclosure. In some aspects, the method comprises combining a stoichiometric amount of one or more metal salt compounds, a solvent, and a chelating agent or surfactant to provide a reaction mixture; stirring the reaction mixture; heating the reaction mixture to evaporate the solvent to provide a gel; heating the gel to obtain a solid precursor material; grinding and/or ball milling the solid precursor material; and calcining the ground precursor material. In particular aspects disclosed herein, the method may further comprise ball milling the obtained powder to form the composition disclosed herein.

In some aspects disclosed herein, the one or more metal salt compounds can be a metal nitrate hexahydrate compound. The metal nitrate hexahydrate compound can be, but is not limited to. La(NO₃)₃6H₂O, Ni(NO)₂6H₂O, Co(NO₃)₂6H₂O, Sr(NO₃)₂6H₂O, Fe(NO₃)₃6H₂O, or any combination thereof. In certain aspects, one or more metal salt compounds can be a metal acetate. The metal acetate can be, but is not limited to, La(CH₃COO)₃, Ni(CH₃COO)₂, Co(CH₃COO)₂, Sr(CH₃COO)₂, Fc(CH₃COO)₃, or any combination thereof. In particular aspects disclosed herein, the one or more metal salt compounds can be a metal chloride compound. The metal chloride compound can be, but is not limited to, LaCl₃, NiCl₂, CoCl₂, SrCl₂, FeCl₃, or any combination thereof.

In aspects disclosed herein, the chelating agent and/or surfactant can be, but is not limited to, citric acid, polyvinylpyrrolidone (PVP), ethylenediaminetetraacetic acid (EDTA), cetyltrimethylarnmonium bromide (CTAB) or tetramethylammonium hydroxide (TMAOH).

In particular aspects disclosed herein, the solvent can be, but is not limited to, deionized water, one or more organic solvents, or any combination thereof. In certain aspects, organic solvents can be, but are not limited to, methanol, ethanol, or isopropanol, or any combination thereof.

In some aspects disclosed herein, the reaction mixture can be heated to evaporate the solvent. In certain aspects, the reaction mixture can be heated at a temperature ranging from 80° C. to 150° C.

In aspects disclosed herein, the gel can be heated to obtain a solid precursor material. In some aspects disclosed herein, the gel can be heated a temperature ranging from 300° C. to 500° C.

In certain aspects disclosed herein, calcining the ground precursor may comprise a temperature ranging from 400° C. to 1000° C.

In aspects disclosed herein, stoichiometric amounts of the metal salt can be dissolved in the solvent. In a non-limiting example, a stoichiometric amount of La(NO₃)₃6H₂O, Ni(NO₃)₂6H₂O and Co(NO₃)₂6H₂O were dissolved in 100 mL of deionized (DI) water (>18.2 MΩ). In certain aspects, chelating agent such as, but not limited to, citric acid (CA) can be added at a molar ratio of 4:1 for the total metal content/CA.

In some aspects, the method comprises hydrothermal growth via the composition disclosed herein. In certain aspects, the method comprises generating one or more self-supported catalyst layers via hydrothermal growth on a PTL (porous transport layer). In aspects disclosed herein, for electrolyte-free alkaline exchange membranes electrolysis, the scalable solution synthesis of LaNiO₃ nano powders is followed by scalable hydrothermal growth of nano-Co₃O₄ surface catalyst phases. In certain aspects of the present disclosure, LaNiₓCo₁₋ₓO₃ nano-powders, where x is 0 to 1, comprising metallic conductivity integrates the pure-water-stable Co-based OER active site into the bulk material. Moreover, these nano-powders exhibit desirable performance in dilute KOH (not free of Fe impurities) as the surface forms Ni(Fe)OOH, while the bulk retains electronically conductive LaNiₓCo₁₋ₓO₃.

In aspects disclosed herein, the method comprises doping LaNiₓCo₁₋ₓO₃ nano-powder to increase surface reconstruction by adding Sr, which leaches to make defects that facilitate the formation of a surface layer of the catalytically active water oxidation phase and oxyhydroxide of Co—Ni—OₓH_{y}. In certain aspects disclosed herein, doping the LaNiₓCo₁₋ₓO₃ nano-powder enhances surface activity without decreasing the electrical conductivity by adding low amounts of Fe substituting Co with a mol % no greater than 50%, creating more active surface phases.

Also disclosed herein are aspects of a method of making a catalyst such as, but not limited, a porous catalyst layer, wherein the method comprises depositing a mixture comprising one or more metal-oxide perovskite nanoparticles disclosed herein, one or more metal salt compounds, a chelating agent or surfactant, and a solvent onto a substrate. In some aspects, the mixture can be a coating ink for coating a substrate. In certain aspects, the method comprises spraying the coating ink onto the substrate at ambient temperature. In some aspects, the substrate is heated during the spraying of the coating ink at a temperature ranging from 50° C. to 150° C. In certain aspects, the method can further comprise heating the catalyst coated substrate to form the porous catalyst layer at a temperature ranging from 25° C. to 1000° C.

Aspects of a method of making a catalyst for anodes such as, but not limited to, Brick and Mortar “B-M” anodes is also disclosed herein, in certain aspects, the method comprises providing a mixture comprising one or more prepared metal-oxide perovskite nanoparticles, a stoichiometric amount of one or more metal salt compounds to form the desired metal-oxide mortar phase, a solvent, and a chelating agent or surfactant to provide a coating ink; stirring the coating ink; spray coating the ink onto a porous substrate; heating the spray coated substrate to evaporate the solvent to provide a precursor anode; and heating the precursor anode to obtain a Brick and Mortar (“B-M”) anode. In certain aspects, the method further comprises ball milling the obtained powder to form the composition disclosed herein.

In certain aspects, the spray coated substrate is heated to a temperature ranging from 25° C. to 800° C. to provide the precursor anode.

In some aspects, the precursor anode is heated to a temperature ranging from 100° C. to 1000° C.

In aspects disclosed herein, the substrate can be an electronically conductive porous substrate electrode support such as, but not limited to, a porous transport layer (PTL) or gas diffusion layer (GDL).

In some aspects disclosed herein, the one or more metal salt compounds can be a metal nitrate hexahydrate compound. The metal nitrate hexahydrate compound can be, but is not limited to, La(NO₃)₃·6H₂O, Ni(NO₃)₂·6H₂O, Co(NO₃)₂·6H₂O, Sr(NO₃)₂·6H₂O, Fe(NO₃)₃·6H₂O, or any combination thereof. In certain aspects, one or more metal salt compounds can be a metal acetate. The metal acetate can be, but is not limited to, La(CH₃COO)₃, Ni(CH₃COO)₂, Co(CH₃COO)₂, Sr(CH₃COO)₂, Fe(CH₃COO)₃, or any combination thereof. In particular aspects disclosed herein, the one or more metal salt compounds can be a metal chloride compound. The metal chloride compound can be, but is not limited to, LaCl₃, NiCl₂, CoCl₂, SrCl₂, FeCl₃, or any combination thereof.

In aspects disclosed herein, the chelating agent and/or surfactant can be, but is not limited to, citric acid, polyvinylpyrrolidone (PVP), ethylenedianinetetraacetic acid (EDTA), cetyltrimethylammonium bromide (CTAB) or tetramethylammonium hydroxide (TMA OH).

In particular aspects disclosed herein, the solvent can be, but is not limited to, deionized water, one or more organic solvents, or any combination thereof. In certain aspects, organic solvents can be, but are not limited to, methanol, ethanol, or isopropanol, or any combination thereof.

### VI. Overview of Several Aspects

Disclosed herein are aspects of a composition, comprising a core comprising one or more metal-oxide perovskite nanoparticles having a formula ABQ, wherein A is La, Sr, or any combination thereof; B is one or more transition metal cations; and Q is Cl_{y}O_{3-y/2} or F_{z}O_{3-z/2}, y is 0 to 3, and z is 0 to 3; a surface layer comprising one or more surface active catalysts; and wherein the one or more metal-oxide nanoparticles are electrocatalytic toward oxygen gas evolution in alkaline conditions, alkaline-ionomer conditions, or a combination thereof.

In any or all the above aspects, the one or more metal-oxide perovskite nanoparticles have a chemical composition of LaNiₓCo₁₋ₓO₃, where x is 0 to 1.

In any or all the above aspects, the one or more metal-oxide perovskite nanoparticles have a chemical composition selected from LaNi_{0.9}Co_{0.1}O₃, LaNi_{0.7}Co_{0.3}O₃, LaNi_{0.5}Co_{0.5}O₃, LaNi_{0.3}Co_{0.7}O₃, or LaNi_{0.1}Co_{0.9}O₃.

In any or all the above aspects, the one or more metal-oxide perovskite nanoparticles comprise La and Sr.

In any or all the above aspects, the one or more metal-oxide perovskite nanoparticles have a chemical composition selected from Sr_{0.1}La_{0.9}Ni_{0.5}Co_{0.5}O₃, Sr_{0.1}La_{0.9}Ni_{0.3}Co_{0.7}O₃, Sr_{0.1}La_{0.9}Fe_{0.05}Ni_{0.3}Co_{0.65}O₃, Sr_{0.1}La_{0.9}Fe_{0.1}Ni_{0.3}Co_{0.6}O₃, or Sr_{0.2}La_{0.8}Fe_{0.05}Ni_{0.3}Co_{0.65}O₃.

In any or all the above aspects, the one or more surface active catalysts comprise a metal-oxide or an (oxy)hydroxide comprising Ni, Co, or a combination thereof.

In any or all the above aspects, the alkaline conditions or alkaline-ionomer conditions comprise one or more solid or liquid electrolytes.

In any or all the above aspects, the core has a diameter of 2 nm to 200 nm.

In any or all the above aspects, the surface layer has a thickness of 1 nm to an upper limit equal to but not exceeding the particle diameter.

In any or all the above aspects, composition comprises an electrical conductivity ranging from 1 S/m to 10⁷ S/m.

Also disclosed herein are aspects of a composition, comprising one or more metal-oxide nanoparticles or porous catalyst layers, comprising an electrically conductive core comprising LaNiₓCo₁₋ₓO₃, where x is 0 to 1; a surface layer comprising one or more surface active catalysts; and wherein the one or more metal-oxide nanoparticles are electrocatalytic toward oxygen gas evolution in alkali conditions, alkaline-ionomer conditions, or a combination thereof.

In any or all the above aspects, the one or more surface-active catalysts comprise a metal-oxide or an (oxy)hydroxide comprising Ni, Co, or a combination thereof.

In any or all of the above aspects, the alkali conditions or alkaline-ionomer conditions comprise one or more solid or liquid electrolytes.

In any or all of the above aspects, the one or more surface-active catalyst(s) are formed via electrochemical reconstruction of the surface layer.

In any or all of the above aspects, the one or more surface-active-phase catalysts are formed via constant-current electrodeposition from a solution comprising one or more soluble metal salts.

In any or all of the above aspects, the one or more surface-active-phase catalysts are formed via physical or chemical-vapor deposition methods followed by constant-current application.

In any or all of the above aspects, the core, surface layer, or combination thereof comprise Sc, Ti, V, Cr, Mn, Fe, Co, Ni, Cu, or any combination thereof.

In any or all of the above aspects, the core, surface layer, or combination thereof further comprise one or more metal-oxide nanoparticles comprising Cl or F.

In any or all of the above aspects, the core, surface layer, or combination thereof further comprise one or more metal-oxide nanoparticles comprising Be, Mg, Ca, Sr, Ba, Ra, or any combination thereof.

In any or all of the above aspects, Be, Mg, Ca, Sr, Ba, Ra, or any combination thereof are leached to form the one or more surface-active-phase catalysts.

In any or all of the above aspects, the core, surface layer, or combination thereof further comprise one or more metal-oxide nanoparticles further comprising Cl or F in the O position.

In any or all of the above aspects, the one or more metal-oxide nanoparticle compositions are LaNiₓCo₁₋ₓCl_{y}O_{3-y/2} or LaNiₓCo₁₋ₓF_{z}O_{3-z/2}, where x is 0 to 1, y is 0 to 3, and z is 0 to 3.

In any or all of the above aspects, the core, surface layer, or combination thereof comprise one or more metal-oxide nanoparticles comprising any lanthanide element substituted for La such that the total molar sum of La and additional substituted elements equal to 1.

In any or all of the above aspects, the one or more metal-oxide nanoparticles core has a diameter of 2 nm to 200 nm.

In any or all of the above aspects, the catalyst surface layer has a thickness of 1 to an upper limit equal to but not exceeding the particle diameter.

In any or all of the above aspects, the molar ratio of Co to Ni has a range from 0 to 1.

In any or all of the above aspects, the core comprises a crystalline structure having an electrical conductivity range of 1 S/m to 10⁷ S/m.

Also disclosed herein are aspects of a composition comprising one or more metal-oxide nanoparticles or porous catalyst layers having a formula ABO₃, wherein: A is one or more rare earth metal cations, one or more alkaline earth metal cations, or any combination thereof; and B is one or more transition metal cations.

In some aspects, A is La, Sr, or any combination thereof.

In any or all of the above aspects, B is NiₓCo₁₋ₓ; and x is 0 to 1.

In any or all of the above aspects, the stoichiometry of 0 ranges from 2-3.

In any or all of the above aspects, the one or more metal-oxide nanoparticles has a perovskite structure and has a chemical composition of LaNi_{0.9}Co_{0.1}O₃.

In any or all of the above aspects, the one or more metal-oxide nanoparticles has a perovskite structure and has a chemical composition of LaNi_{0.7}Co_{0.3}O₃.

In any or all of the above aspects, the one or more metal-oxide nanoparticles have a perovskite structure and has a chemical composition of LaNi_{0.5}Co_{0.5}O₃.

In any or all of the above aspects, the one or more metal-oxide nanoparticles have a perovskite structure and has a chemical composition of Sr_{0.1}La_{0.9}Ni_{0.5}Co_{0.5}O₃.

In any or all of the above aspects, one or more metal-oxide nanoparticles have a perovskite structure and a chemical composition of Sr_{0.1}La_{0.9}Ni_{0.3}Co_{0.7}O₃.

In any or all of the above aspects, one or more metal-oxide nanoparticles have a perovskite structure and a chemical composition of LaNi_{0.3}Co_{0.7}O₃.

In any or all of the above aspects, the one or more metal-oxide nanoparticles have a perovskite structure and a chemical composition of LaNi_{0.1}Co_{0.9}O₃.

In any or all of the above aspects, B further comprises Fe substituting Co with a mol % no greater than 50%.

In any or all of the above aspects, the one or more metal-oxide nanoparticles have a perovskite structure and a chemical composition of Sr_{0.1}La_{0.9}Fe_{0.05}Ni_{0.3}Co_{0.65}O₃.

In any or all of the above aspects, the one or more metal-oxide nanoparticles have a perovskite structure and a chemical composition of Sr_{0.1}La_{0.9}Fe_{0.1}Ni_{0.3}Co_{0.6}O₃.

In any or all of the above aspects, the one or more metal-oxide nanoparticles have a perovskite structure and a chemical composition of Sr_{0.2}La_{0.8}Fe_{0.05}Ni_{0.3}Co_{0.6503.}

Aspects of a method of making the composition disclosed herein comprising one or more metal-oxide nanoparticles or porous catalyst layers is also disclosed herein, the method comprising: combining a stoichiometric amount of one or more metal-salt compounds, a solvent, and a chelating agent or surfactant to provide a reaction mixture; stirring the reaction mixture; heating the reaction mixture to evaporate the solvent to provide a gel; heating the gel to obtain a solid precursor material; grounding and/or ball milling the solid precursor material; and calcining the ground precursor material.

In some aspects, the method may further comprise ball milling the obtained powder to form the composition disclosed herein.

In any or all of the above aspects, the metal nitrate hexahydrate compound is La(NO₃)₃·6H₂O, Ni(NO₃)₂·6H₂O, Co(NO₃)₂·6H₂O, Sr(NO₃)₂·6H₂O, Fe(NO₃)₃·6H₂O, or any combination thereof.

In any or all of the above aspects, wherein the metal acetate compound is La(CH₃COO)₃, Ni(CH₃COO)₂, Co(CH₃COO)₂, Sr(CH₃COO)₂, Fe(CH₃COO)₃, or any combination thereof.

In any or all of the above aspects, the metal chloride compound is LaCl₃, NiCl₂, CoCl₂, SrCl₂, FeCl₃, or any combination thereof.

In any or all of the above aspects, the chelating agent is citric acid, polyvinylpyrrolidone (PVP), ethylenediaminetetraacetic acid (EDTA), cetyltrimethylammonium bromide (CTAB), or tetramethylammonium hydroxide (TMAOH).

In any or all of the above aspects, the solvent is deionized water, one or more organic solvents, or any combination thereof.

In any or all of the above aspects, the solvent is methanol, ethanol, or isopropanol, or any combination thereof.

In any or all of the above aspects, heating the reaction mixture to evaporate the solvent comprises a temperature ranging from 80° C. to 150° C.

In any or all of the above aspects, heating the gel to obtain a solid precursor material comprises a temperature ranging from 300° C. to 500° C.

In any or all of the above aspects, calcining the ground precursor comprises a temperature ranging from 400° C. to 900° C.

Aspects of a method of making an anode is also disclosed herein, the method comprising providing a coating ink comprising a stoichiometric amount of one or more metal salt compounds, a solvent, a chelating agent or surfactant, and one or more perovskite nanoparticles having a formula ABQ, wherein: A is La, Sr, or any combination thereof; B is one or more transition metal cations; and Q is Cl_{y}O_{3-y/2} or F_{z}O_{3-z/2}, y is 0 to 3, and z is 0 to 3; stirring the coating ink; spraying the coating ink onto a substrate; heating the spray coated substrate to a temperature ranging from 25° C. to 800° C. to provide a precursor anode; and heating the precursor anode to a temperature ranging from 100° C. to 1000° C.

In any or all of the above aspects, the one or more metal salt compounds are a metal nitrate hexahydrate compound, metal acetate compound, or a metal chloride compound.

In any or all of the above aspects, the one or more metal salt compounds are selected from: (i) La(NO₃)₃·6H₂O, Ni(NO₃)₂·6H₂O, Co(NO₃)₂·6H₂O, Sr(NO₃)₂·6H₂O, Fe(NO₃)₃·6H₂O, or any combination thereof; (ii) La(CH₃COO)₃, Ni(CH₃COO)₂, Co(CH₃COO)₂, Sr(CH₃COO)₂, Fe(CH₃COO)₃, or any combination thereof; or (iii) LaCl₃, NiCl₂, CoCl₂, SrCl₂, FeCl₃, or any combination thereof.

In any or all of the above aspects, the chelating agent is citric acid, polyvinylpyrrolidone (PVP), ethylenediaminetetraacetic acid (EDTA), cetyltrimethylammonium bromide (CTAB), or tetramethylammonium hydroxide (TMAOH).

Also disclosed herein are aspects of an alkaline-exchange-membrane ionomer-based, hybrid liquid-alkaline, alkaline-ionomer electrolyzer comprising an anode, wherein the anode comprises (i) an ionomer and (ii) the composition disclosed herein.

Also disclosed herein are aspects of a liquid alkaline electrolyzer comprising an anode, wherein the anode comprises one or more catalysts comprising the composition disclosed herein.

### VII. Examples

Aspects of the present teachings can be further understood in light of the following examples. Catalysts comprising the composition disclosed herein were prepared and tested.

Preparation Chemistry: The LaNiₓCo₁₋ₓO₃ series (x=0, 0.1, 0.3, 0.5, 0.7, 0.9, 1) were synthesized using conventional sol-gel method. A stoichiometric amount of La(NO₃)₃6H₂O, Ni(NO₃)₂6H₂O and Co(NO₃)₂6H₂O were dissolved in 100 mL of deionized (DI) water (>18.2 MΩ). Citric acid (CA) was added at a molar ratio of 4:1 for the total metal content/CA. After stirring for 30 minutes, the mixed solution was heated on a hot plate at the temperature of 100° C. to evaporate all water. The obtained gel was transferred into a box furnace at 400° C. for 4 h to allow the decomposition of the remaining organic items and nitrates. The obtained solid precursor was thoroughly grounded using a mortar and pestle, and further calcined at 700° C. for 6 hours to obtain the final products.

The Sr-doped and Sr/Fe co-doped perovskite series: Sr_{y}La_{1-y}NiₓCo₁₋ₓO₃ and Sr_{y}La_{1-y}Fe_{z}NiₓCo_{1-x-z}O₃ were synthesized following the same procedures. The A-site and B-site nitrate salts were weighed according to the metal ratios designated in the chemical formulae. For each synthesis, 5 mmol perovskite catalyst was prepared and the yield of the as-prepared oxide powder is around 1.2 g.

Preparation chemistry of self-supported perovskite anode on metal porous transport layer by “Brick and Mortar” method: The “brick” nanoparticle ink was prepared by dispersing 100 mg prepared perovskite powder in 0.5 g of water and 1.7 g of isopropanol. Then the “mortar” with a stoichiometric amount of La(NO₃)₃·6H₂O, Ni(NO₃)₂·6H₂O and citric acid (brick:mortar=9:1 metal ion mol ratio) was dissolved in the “brick” ink. The obtained coating ink was sprayed to Ni PTL on a hot plate at 200° C., and the spray-coated Ni PTL was heated at 700° C. for 2 h in a box furnace to obtain the final “B-M” anode.

### Example 1

Structure Characterization and Electrical Conductivity of Perovskite Nanoparticles: The crystalline structure was investigated by powder X-ray diffraction (XRD) analysis for LaNiₓCo₁₋ₓO₃ at different x (x=0, 0.3, 0.5, 1); Sr_{0.1}La_{0.9}Ni_{0.3}Co_{0.7}O₃; and Sr_{0.1}La_{0.9}Fe_{0.05}Ni_{0.3}Co_{0.65}O₃ samples; and standard XRD profiles of LaNiO₃ (JCPDS NO. 10-0341) and LaCoO₃ (JCPDS NO. 09-0358). Additionally, the electrical conductivity LaNiₓCo₁₋ₓO₃ (x=0, 0.1, 0.3, 0.5, 0.7, 0.9, 1), Sr/Fe doped LaNiₓCo₁₋ₓO₃ perovskites and commercial Co₃O₄ (30-50 nm) at room temperature were tested using the four-probe method.

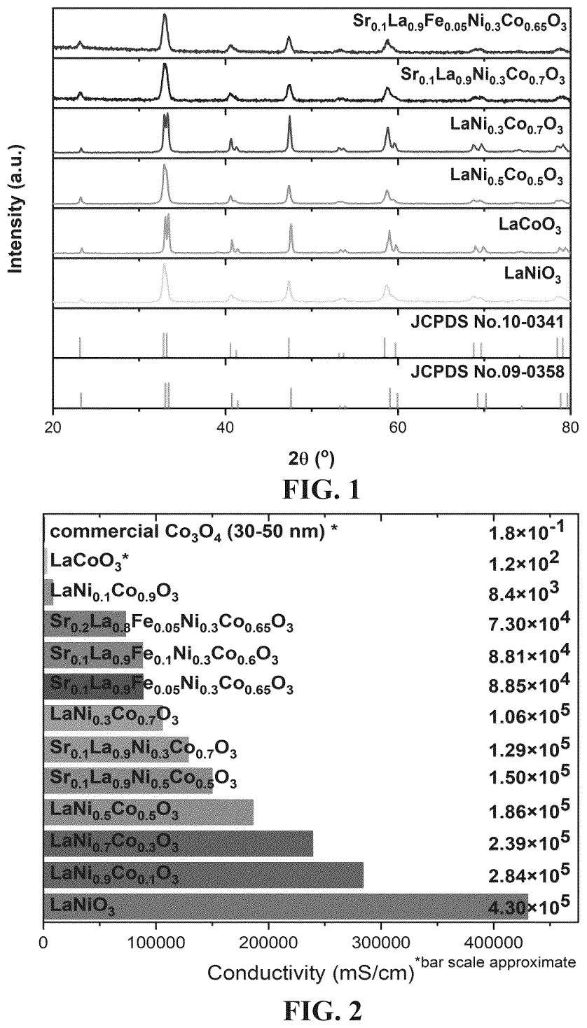

As shown in FIG. 1, the XRD data demonstrates that the perovskites exhibit a single perovskite phase, possessing a hexagonal crystal structure (space group: R-3m) without detectable impurity phases. For the LaNiₓCo₁₋ₓO₃ series with varying ratios of Ni/Co at the B site, the lattice parameters increase with the increasing ratio of Ni³⁺/Co³⁺, and the characteristic peaks were observed to gradually shift towards a lower angle due to the larger ionic radius of Ni³⁺ (0.56 Å) as compared to Co³⁺ (0.54 Å). Furthermore, when 10% La³⁺ at the A site was replaced by Sr²⁺, Sr_{0.1}La_{0.9}Ni_{0.3}Co_{0.7}O₃, demonstrated lower diffraction peaks than LaNi_{0.3}Co_{0.7}O₃, owing to the larger ionic radius of Sr²⁺ (Sr²⁺:1.18 Å and La³⁺:1.03 Å).

FIG. 2 shows the electrical conductivity of commercial Co₃O₄ (30-50 nm, 1.8×10⁻¹ mS/cm) and compared to LaCoO₃ (1.2×10² mS/cm); LaNi_{0.1}Co_{0.9}O₃ (8.4×10³ mS/cm) Sr_{0.2}La_{0.8}Fe_{0.05}Ni_{0.3}Co_{0.65}O₃ (7.30×10⁴ mS/cm); Sr_{0.1}La_{0.9}Fe_{0.1}Ni_{0.3}Co_{0.6}O₃ (8.81×10⁴ mS/cm); Sr_{0.1}La_{0.9}Fe_{0.05}Ni_{0.3}Co_{0.65}O₃ (8.85×10⁴ mS/cm); LaNi_{0.3}Co_{0.7}O₃ (1.06×10⁵ mS/cm); Sr_{0.1}La_{0.9}Ni_{0.3}Co_{0.7}O₃ (1.29×10⁵ mS/cm); Sr_{0.1}La_{0.9}Ni_{0.5}Co_{0.5}O₃ (1.50×10⁵ mS/cm); LaNi_{0.5}Co_{0.5}O₃ (1.86×10⁵ mS/cm); LaNi_{0.7}Co_{0.3}O₃ (2.39×10⁵ mS/cm); LaNi_{0.9}Co_{0.1}O₃ (2.84×10⁵ mS/cm); and LaNiO₃ (4.30×10⁵ mS/cm).

Therefore, this example demonstrates that LaNiO₃ exhibited an electrical conductivity (4.30×10⁵ mS/cm) larger than that of LaCoO₃ (120 mS/cm) and commercial Co₃O₄ (30-50 nm, 0.18 mS/cm) and the introduction of Ni into the Co site of LaCoO₃ exhibited a large increase in the electrical conductivity. Even with only 30% Ni substitution at the B site, LaNi_{0.3}Co_{0.7}O₃ demonstrated a comparable magnitude of conductivity (1.06×10⁵ mS/cm) to LaNiO₃. Furthermore, the addition of 10% Sr further increased the conductivity in Sr_{0.1}La_{0.9}Ni_{0.3}Co_{0.7}O₃ (1.29×10⁵ mS/cm) and despite a slight decrease in electrical conductivity due to a small amount of Fe doping, Sr_{0.1}La_{0.9}Fe_{0.05}Ni_{0.3}Co_{0.65}O₃ (8.85×10⁴ mS/cm) and Sr_{0.1}La_{0.9}Fe_{0.1}Ni_{0.3}Co_{0.6}O₃ (8.81×10⁴ mS/cm), exhibited metallic behaviors with desirable conductivity.

### Example 2

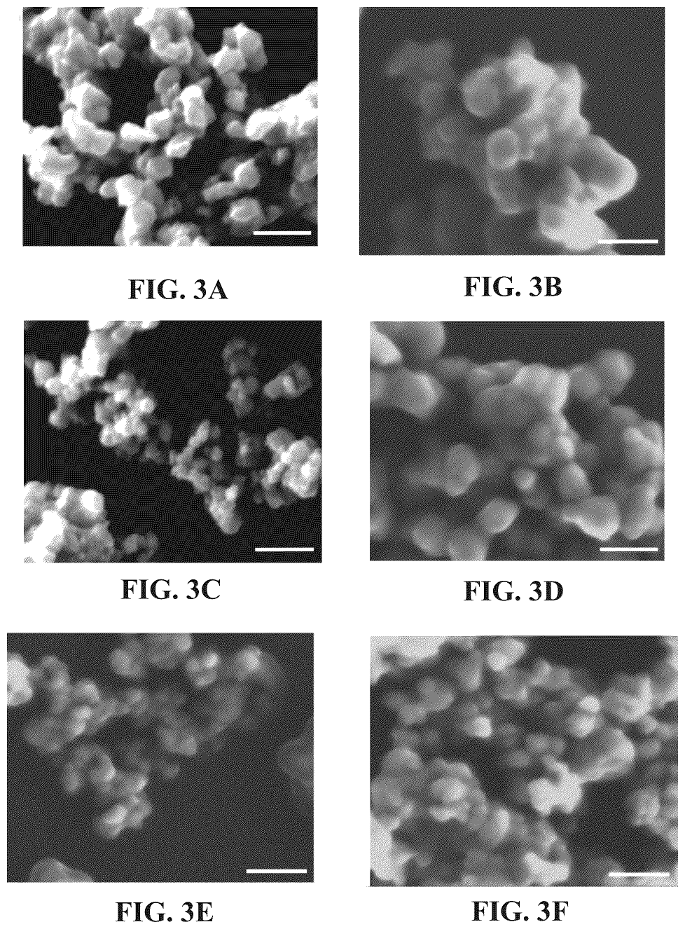

Morphology of Perovskite Nanoparticles: Images obtained through scanning electron microscopy (SEM) are shown in FIGS. 3A-3F. As shown in FIG. 3B, LaCoO₃ demonstrated a relatively larger particle size of 50-150 nm as compared to LaNiO₃, shown in FIG. 3A, exhibited a size range of 30 nm to 100 nm. FIG. 3C shows the SEM images of LaNi_{0.5}Co_{0.5}O₃, which exhibited a reduced and uniform particle size of 20-70 nm with the substitution of 50% of Co with Ni. However, in view of FIG. 3D, LaNi_{0.3}Co_{0.7}O₃ demonstrated a similar particle size as LaCoO₃, even though 30% Ni was introduced at the B site. A decrease in particle size was observed with 10% Sr-doping as shown in FIG. 3E, for Sr_{0.1}La_{0.9}Ni_{0.3}Co_{0.7}O₃, and in FIG. 3F, for Sr_{0.1}La_{0.9}Fe_{0.05}Ni_{0.3}Co_{0.65}O₃, which exhibited an average size of 30-70 nm. Therefore, the perovskites possess a nanoparticle structure with a diameter ranging from 20-150 nm.

### Example 3

Electrical Performance and Durability of Perovskite Nanoparticles: The catalytic activity of the prepared perovskite catalysts and commercial Co₃O₄ (30-50 nm) (catalyst inks containing 10 wt % piperION ionomer) were evaluated on Au/Ti quartz-crystal electrodes in Fe-free 1 M KOH electrolytes. The microscopic current density was calculated using the BET surface areas of the catalyst powders and the overpotential was iR corrected.

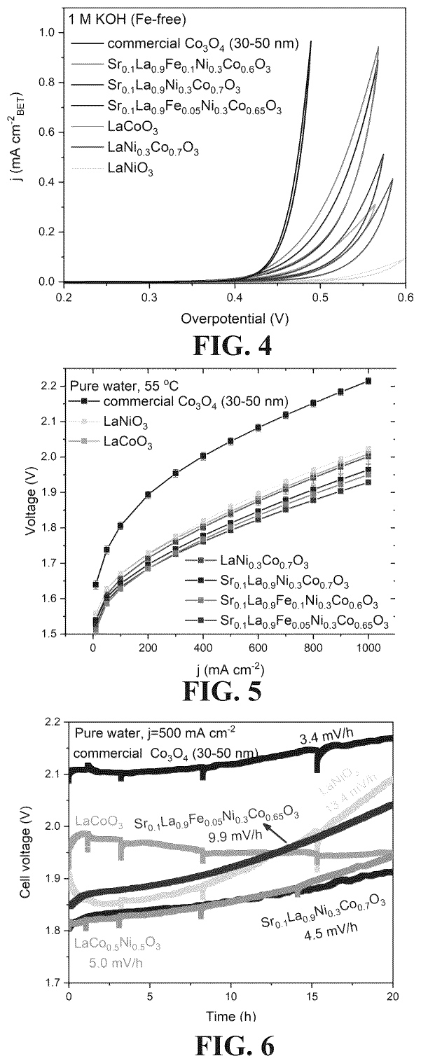

Cyclic voltammetry data for the prepared perovskite catalysts embedded in anion-exchange ionomer is shown in FIG. 4. LaNiO₃ exhibited the lowest activity despite possessing higher charge transfer capability and electrical conductivity. By increasing the amount of Co in the Ni site, LaNi_{0.3}Co_{0.7}O₃ displayed increased activity, comparable to LaCoO₃ but lower than commercial Co₃O₄ (30-50 nm). During the OER process, thin active phase layers such as Ni/CoOOH are formed on the surface of the perovskite catalyst, while the core retains high crystallinity. Additionally, Sr_{0.1}La_{0.9}Ni_{0.3}Co_{0.7}O₃ exhibited higher current density and an increased thickness of surface-active phases, providing more active sites. The introduction of low concentrations of Fe in Sr_{0.1}La_{0.9}Fe_{0.1}Ni_{0.3}Co_{0.6}O₃ and Sr_{0.1}La_{0.9}Fe_{0.05}Ni_{0.3}Co_{0.65}O₃ demonstrated similar activity when compared to Sr_{0.1}La_{0.9}Ni_{0.3}Co_{0.7}O₃.

The performance and durability of each catalyst in an AEM electrolyzers were evaluated at 55° C. with pure water feed. The anode catalysts were sprayed on a stainless-steel woven mesh, while the cathode catalysts were sprayed on Toray-090 carbon paper. The catalyst loading for all samples ranged between 2.5 and 3.0 mg cm⁻², with 10% ionomer content by weight. A thin layer of ionomer, 5-10 wt. % relative to the catalyst loading, was sprayed on top of the catalyst layer. The membrane electrode assemblies (MEAs) were constructed using a 40 μm thick PiperION TP-85 membrane and compressed by applying a torque of 5.6 N m on the assembly bolts. Water at 60° C. was circulated to the anode and cathode at a flow rate of 125 mL min⁻¹ to achieve thermal equilibrium at 55° C. The cell was conditioned by stepping the current up to 1 A cm⁻² and then down before data collection.

The perovskite catalysts outperformed commercial Co₃O₄ (30-50 nm) catalysts by 80-100 mV at 10 mA cm⁻². Along with the increase of the current density, the voltage of LaNiO₃ was around 200 mV lower than that of commercial Co₃O₄ (30-50 nm) at 1 A cm⁻², but slightly higher than that of LaCoO₃ due to the higher intrinsic activity of Co-based active sites compared to Ni-based active sites. LaNi_{0.3}Co_{0.7}O₃ displayed better performance than LaNiO₃ and LaCoO₃. After Sr doping, Sr_{0.1}La_{0.9}Ni_{0.3}Co_{0.7}O₃ exhibited a lower voltage of 1.96 V at 1 Å cm⁻². With the substitution of 5-10% Fe in the Co site, Sr_{0.1}La_{0.9}Fe_{0.05}Ni_{0.3}Co_{0.65}O₃ exhibited an improvement in performance with a voltage of 1.93 V at 1 Å cm⁻².

The durability of the electrodes comprising ionomers and the OER catalysts was assessed by 20-hour test at 500 mA cm⁻² in pure water at 55° C. LaNiO₃ exhibited high degradation, with a degradation rate of 13.4 mV/h over 20 h, higher than commercial Co₃O₄ (3.4 mV/h). In contrast, LaCoO₃ showed no degradation during the 20-hour test, indicating a more stable surface and consistent with lower electrical conductivity. By achieving this suitable metal ratio, both LaNi_{0.5}Co_{0.5}O₃ and Sr_{0.1}La_{0.9}Ni_{0.3}Co_{0.7}O₃ demonstrated relatively lower degradation rates of 5.0 and 4.5 mV/h, respectively. However, even with 5% Fe doping, the degradation rate of Sr_{0.1}La_{0.9}Fe_{0.05}Ni_{0.3}Co_{0.65}O₃ remained high (9.9 mV/h), similar to the high degradation rates observed in the Fe-containing catalysts.

### Example 4

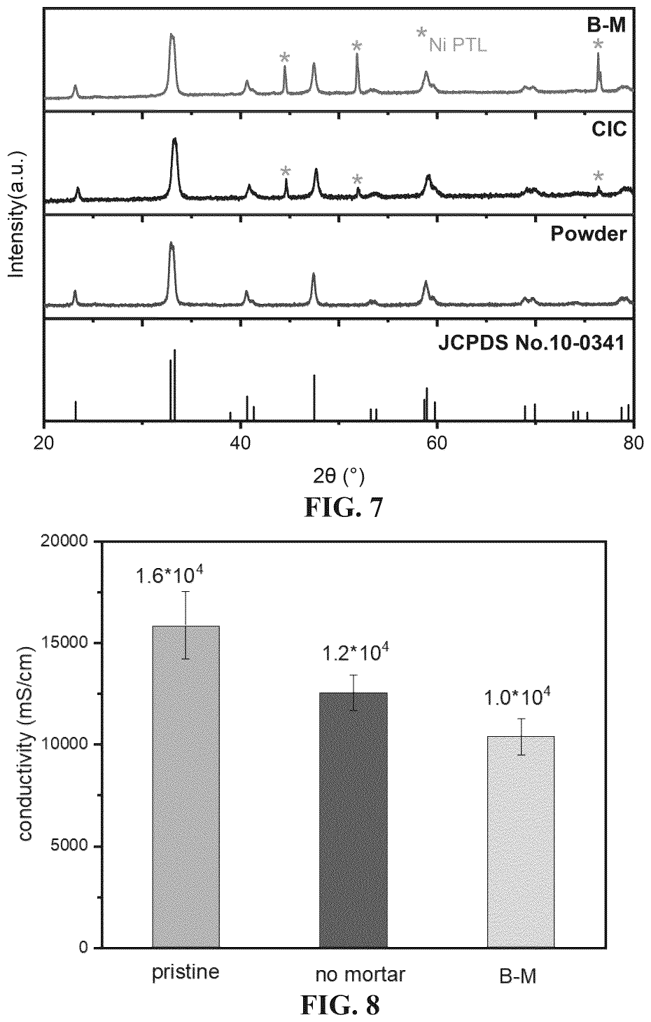

Structure Characterization and Electrical Conductivity of Perovskite Self-supported Catalyst Layers: The crystalline structure of perovskite self-supported anode prepared by “Brick and Mortar” method (labeled as B-M) and conventional catalyst-ionomer-coated anode (labeled as CIC), Sr/Co doped LaNiO₃ powder, and standard XRD profiles of LaNiO₃ (JCPDS NO. 10-0341) were compared in FIG. 7. Both “B-M” and “CIC” anode exhibited perovskite phase without detectable impurity phases, consistent with that of the pristine powder. The detected Ni metal peaks were from Ni porous transport layers. FIG. 8 shows the electrical conductivities of regrind and pressed pellets of Sr/Co doped LaNiO₃ perovskite powder (1.6×10⁴ mS/cm), powder removed from “Brick” ink coated anode (1.2×10⁴ mS/cm) and powder removed from “Brick-Mortar” ink coated anode (1.0×10⁴ mS/cm). This example demonstrates that despite a slight decrease in electrical conductivity due to a small amount of “Mortar”, the catalyst powder on “B-M” anode maintained highly-conducting behavior with the same order of magnitude of electrical resistance as the pristine perovskite powder.

### Example 5

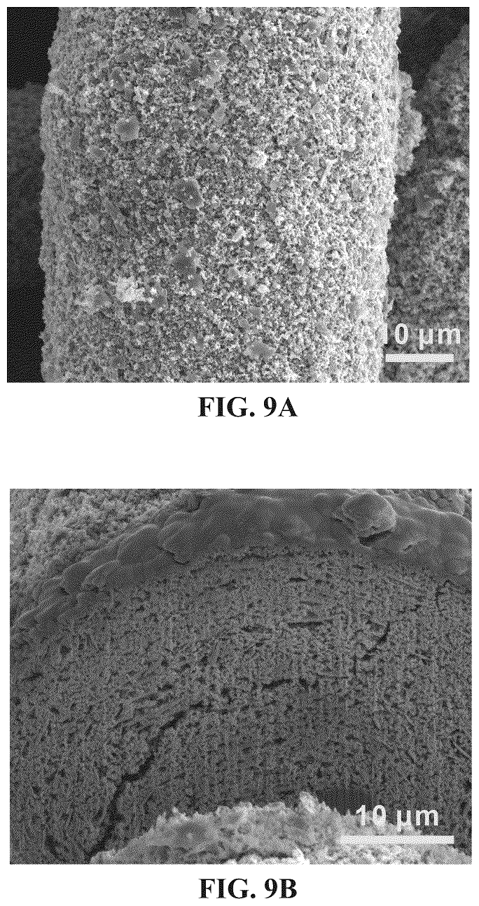

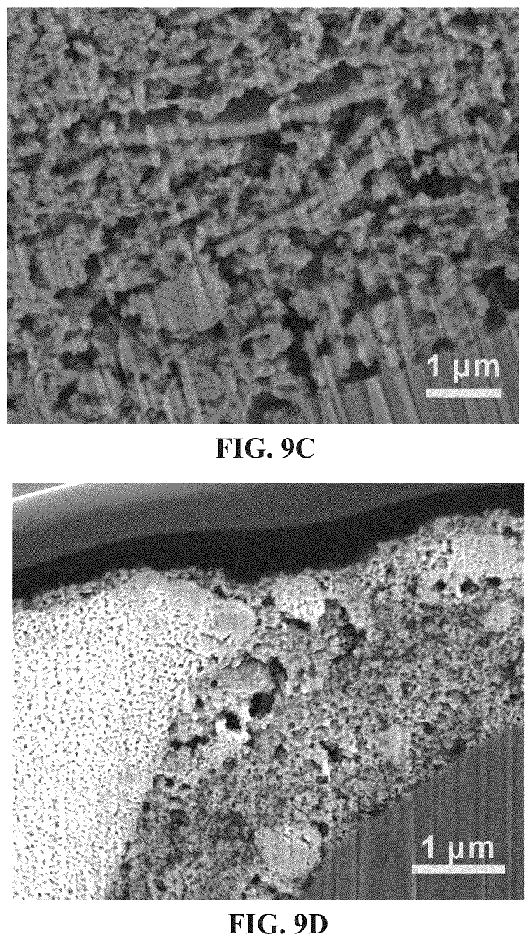

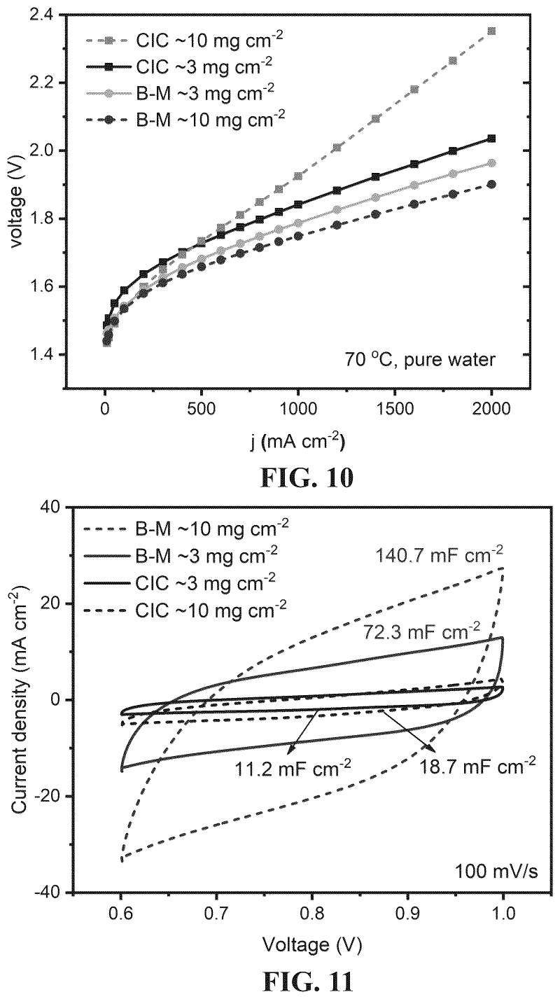

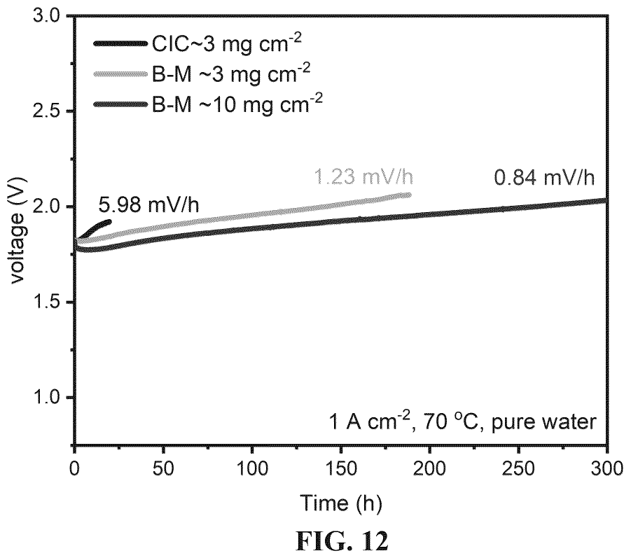

Morphology of Perovskite Self-supported Catalyst Layers: SEM images of constructed anodes are shown in FIGS. 9A-9D. “B-M” anode is demonstrated to be porous, uniform, with a continuous structure of the perovskite catalyst layer from the surface based on the cross-sectional images (FIGS. 9A-9B). After coating PiperION ionomer, it maintained a porous structure with ionomer uniformly dispersed in the pores (FIG. 9C). However, the “CIC” anode demonstrated aggregation and non-uniform distribution of catalyst nanoparticles and ionomers (FIG. 9D). In FIGS. 9C-9D, the perovskite catalyst layers or particles exhibited a brighter color, while ionomers were darker.

### Example 6

Electrocatalytic Performance, Double-layer Capacitance and Durability of Perovskite Self-supported Catalyst Layers: “B-M” anodes were dip- and spray-coated with a 5 wt % Zr-PiperION ionomer dispersion, prepared with a ratio of Zr propoxide:5 wt % PiperION=1:9 wt %) until its loading reached 2 mg cm⁻². “CIC” anode was prepared by spray-coating perovskite catalyst-PiperION ionomer ink on the Ni PTL with 10 wt % top coating of PiperION ionomer. The performance, electrochemical active surface area and durability of AEM electrolyzers with different anodes were evaluated at 70° C. with pure water feed.

The AEMWE single cell with “B-M” anode (catalyst loading: 10 mg cm⁻²) exhibited the best performance with the cell voltage of 1.90 V at 2 Å cm⁻², 60 mV and 140 mV lower than those with the catalyst loading of 3 mg cm⁻² of “B-M” anode and “CIC” anode, respectively. “B-M” anodes outperformed “CIC” anodes due to the formation of continuous catalyst layers during “B-M” method, while maintaining the metallic conductivity achieved during the initial perovskite nanoparticle synthesis step. After increasing the catalyst loading to 10 mg cm⁻² for “CIC” anode, the AEMWE exhibited low performance with a cell voltage of 2.35 V at 2 Å cm⁻², losing the advantage of metallic property of perovskite nanoparticles, perhaps due to loss of particle-to-particle interconnection.

The double-layer capacitance (C_{dl}) was calculated to estimate the electrochemically active surface area (ECSA) for different catalysts from the non-faradaic charging currents by sweeping the voltage between 0.6 V to 1.0 V in the two-electrode electrolyzer configuration. In this two-electrode configuration, the measured capacitance would be dominated by the catalysts loaded on the anode because of the large loading of Pt on porous carbon at the cathode. The C_{dl} values of “B-M” anodes, measured in the two-electrode configuration with catalyst loading of 3 and 10 mg cm⁻², were 72.3 and 140.7 mF cm⁻², respectively, both higher than those of “CIC” anodes (11.2 and 18.7 mF cm⁻² for the catalyst loading of 3 and 10 mg cm⁻²).

The durability of AEMWEs with different anodes was tested at 1 Å cm⁻² at 70° C. with pure water feed. The AEMWE cell with the “CIC” anode exhibited poor stability, with a degradation rate of ˜6 mV/h over 20 h, while those with “B-M” anodes for different catalyst loading (3 and 10 mg cm⁻²) showed improved stability with the degradation rate of ˜1 mV/h over hundred hours.

In view of the many possible aspects to which the principles of the present disclosure may be applied, it should be recognized that the illustrated aspects are only preferred examples of the invention and should not be taken as limiting the scope of the invention. Rather, the scope of the invention is defined by the following claims. We therefore claim as our invention all that comes within the scope and spirit of these claims.

We claim:

1. A composition, comprising:
a core comprising one or more metal-oxide perovskite nanoparticles having a formula ABQ, wherein:
A is La, Sr, or any combination thereof;
B is one or more transition metal cations; and
Q is Cl_{y}O_{3-y/2} or F_{z}O_{3-z/2}, y is 0 to 3, and z is 0 to 3;
a surface layer comprising one or more surface active catalysts; and
wherein the one or more metal-oxide nanoparticles are electrocatalytic toward oxygen gas evolution in alkaline conditions, alkaline-ionomer conditions, or a combination thereof.

2. The composition of claim 1, wherein the one or more metal-oxide perovskite nanoparticles have a chemical composition of LaNiₓCo₁₋ₓO₃, where x is 0 to 1.

3. The composition of claim 2, wherein the one or more metal-oxide perovskite nanoparticles have a chemical composition selected from LaNi_{0.9}Co_{0.1}O₃, LaNi_{0.7}Co_{0.3}O₃, LaNi_{0.5}Co_{0.5}O₃, LaNi_{0.3}Co_{0.7}O₃, or LaNi_{0.1}Co_{0.9}O₃.

4. The composition of claim 1, wherein the one or more metal-oxide perovskite nanoparticles comprise La and Sr.

5. The composition of claim 4, wherein the one or more metal-oxide perovskite nanoparticles have a chemical composition selected from Sr_{0.1}La_{0.9}Ni_{0.5}Co_{0.5}O₃, Sr_{0.1}La_{0.9}Ni_{0.3}Co_{0.7}O₃, Sr_{0.1}La_{0.9}Fe_{0.05}Ni_{0.3}Co_{0.65}O₃, Sr_{0.1}La_{0.9}Fe_{0.1}Ni_{0.3}Co_{0.6}O₃, or Sr_{0.2}La_{0.8}Fe_{0.05}Ni_{0.3}Co_{0.65}O₃.

6. The compositions of claim 1, wherein the one or more surface active catalysts comprise a metal-oxide or an (oxy)hydroxide comprising Ni, Co, or a combination thereof.

7. The composition of claim 1, wherein the alkaline conditions or alkaline-ionomer conditions comprise one or more solid or liquid electrolytes.

8. The composition of claim 1, wherein the core has a diameter of 2 nm to 200 nm.

9. The composition of claim 1, wherein the surface layer has a thickness of 1 nm to an upper limit equal to but not exceeding the particle diameter.

10. The composition of claim 1, wherein composition comprises an electrical conductivity ranging from 1 S/m to 10⁷ S/m.

11. A method of making the composition of claim 1, comprising:
providing a stoichiometric amount of one or more metal salt compounds, a solvent, and a chelating agent or surfactant to form a reaction mixture;
stirring the reaction mixture;
heating the reaction mixture to a temperature ranging from 80° C. to 150° C. to provide a gel;
heating the gel to a temperature ranging 300° C. to 500° C. to obtain a solid precursor material;
grinding and/or ball milling the solid precursor material; and
calcining the ground precursor material at a temperature ranging from 400° C. to 900° C.

12. The method of claim 11, wherein one or more metal salt compounds are a metal nitrate hexahydrate compound, metal acetate compound, or a metal chloride compound.

13. The method of claim 12, wherein one or more metal salt compounds are selected from:
(i) La(NO₃)₃·6H₂O, Ni(NO₃)₂·6H₂O, Co(NO₃)₂·6H₂O, Sr(NO₃)₂·6H₂O, Fe(NO₃)₃·6H₂O, or any combination thereof;
(ii) La(CH₃COO)₃, Ni(CH₃COO)₂, Co(CH₃COO)₂, Sr(CH₃COO)₂, Fe(CH₃COO)₃, or any combination thereof: or
(iii) LaCl₃, NiCl₂, CoCl₂, SrCl₂, FeCl₃, or any combination thereof.

14. The method of claim 11, wherein the chelating agent is citric acid, polyvinylpyrrolidone (PVP), ethylenediaminetetraacetic acid (EDTA), cetyltrimethylammonium bromide (CTAB), or tetramethylammonium hydroxide (TMAOH).

15. A method of making an anode, comprising:
providing a coating ink comprising a stoichiometric amount of one or more metal salt compounds, a solvent, a chelating agent or surfactant, and one or more perovskite nanoparticles having a formula ABQ, wherein:
A is La, Sr, or any combination thereof;
B is one or more transition metal cations; and
Q is Cl_{y}O_{3-y/2} or F_{z}O_{3-z/2}, y is 0 to 3, and z is 0 to 3;
stirring the coating ink;
spraying the coating ink onto a substrate;
heating the spray coated substrate to a temperature ranging from 25° C. to 800° C. to provide a precursor anode; and
heating the precursor anode to a temperature ranging from 100° C. to 1000° C.

16. The method of claim 15, wherein the one or more metal salt compounds are a metal nitrate hexahydrate compound, metal acetate compound, or a metal chloride compound.

17. The method of claim 16, wherein one or more metal salt compounds are selected from:
(i) La(NO₃)₃·6H₂O, Ni(NO₃)₂·6H₂O, Co(NO₃)₂·6H₂O, Sr(NO₃)₂·6H₂O, Fe(NO₃)₃·6H₂O, or any combination thereof;
(ii) La(CH₃COO)₃, Ni(CH₃COO)₂, Co(CH₃COO)₂, Sr(CH₃COO)₂, Fe(CH₃COO)₃, or any combination thereof: or
(iii) LaCl₃, NiCl₂, CoCl₂, SrCl₂, FeCl₃, or any combination thereof.

18. The method of claim 15, wherein the chelating agent is citric acid, polyvinylpyrrolidone (PVP), ethylenediaminetetraacetic acid (EDTA), cetyltrimethylammonium bromide (CTAB), or tetramethylammonium hydroxide (TMAOH).

19. An alkaline-exchange-membrane ionomer-based, hybrid liquid-alkaline, alkaline-ionomer electrolyzer comprising an anode, wherein the anode comprises (i) an ionomer and (ii) the composition of claim 1.

20. A liquid alkaline electrolyzer comprising an anode, wherein the anode comprises one or more catalysts comprising the composition of claim 1.
